(19) United States
(12) Patent Application Publication
(10) Pub. No.: US 2010/0146151 A1
(43) Pub. Date: Jun. 10, 2010

(54) ROUTING PATH ESTABLISHMENT APPARATUS AND METHOD IN ZIGBEE NETWORK

(75) Inventors: Hoon Jeong, Daejeon-si (KR); Jong-jun Park, Daejeon-si (KR); Seong-soon Joo, Daejeon-si (KR); Jong-suk Chae, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/626,054

(22) Filed: Nov. 25, 2009

(30) Foreign Application Priority Data
Dec. 10, 2008 (KR) 10-2008-0125311

(51) Int. Cl. G06F 15/173

(52) U.S. Cl. 709/242

(57) ABSTRACT

An apparatus and method for establishing a routing path in a ZigBee network including a device in sleep mode is provided. The method includes receiving a route request command, and establishing a path with reference to sleep information of a destination device and of all devices located on a path to the destination device. Accordingly, while the devices are allowed to sleep for energy efficiency even in a non-beacon-enabled mode, an ad-hoc on-demand distance vector (AODV)-based mesh routing method which uses a route request command (RREQ) and a route reply command (RREP) can be used as is, and thus the ZigBee network can be utilized in more various application fields.

### CROSS REFERENCE TO RELATED APPLICATION

This application claims the benefit under 35 U.S.C. §119(a) of Korean Patent Application No. 10-2008-0125311, filed on Dec. 10, 2008, the disclosure of which is incorporated by reference in its entirety for all purposes.

### BACKGROUND

1. Field

The following description relates to routing, and more particularly, to a routing path establishment apparatus and method in a ZigBee network including a sleeping device.

2. Description of the Related Art

ZigBee networks operate in a beacon-enabled mode and a non-beacon-enabled mode. In a beacon-enabled mode, to improve energy efficiency of ZigBee devices operated in the ZigBee network, a receiver of each ZigBee device is activated for a predetermined period of time, and is deactivated thereafter to prevent power consumption of the receiver.

The beacon-enabled mode is beneficial in terms of energy efficiency, but has to transmit a beacon signal periodically. In addition, since carrier sense multiple access/collision avoidance (CSMA/CA) is not used in transmission of a beacon signal, the beacon-enabled mode cannot be operated stably in an environment where different types of wireless equipments such as wireless LAN and Bluetooth are implemented together. Moreover, in the beacon-enabled mode, since devices activate their receiver only in an area where the devices and their parent devices are located, a mesh routing method cannot be used.

On the other hand, in the non-beacon-enabled mode, routers included in the network have their receiver activated at all times. Thus, an ad-hoc on-demand distance vector (AODV)-based mesh routing method in which a message about a routing path is broadcasted to a plurality of devices to set a routing path can be used. However, in the non-beacon-enabled mode, because all routers have their receiver activated at all times, there is a great amount of power consumption.

### SUMMARY

Accordingly, in one aspect, there is provided an apparatus and method for establishing a routing path in an Institute of Electrical and Electronics Engineers (IEEE) 802.15.4-based ZigBee network which includes a device in sleep mode for energy efficiency.

More specifically, there is provided an apparatus and method for establishing an ad-hoc is on-demand distance vector (AODV)-based mesh routing path in a ZigBee network which includes a device entering sleep mode in a beacon-enabled mode.

In one general aspect, there is provided a routing path establishment method including receiving a route request command, and establishing a path with reference to sleep information of a destination device and of all devices located on a path to the destination device.

The sleep information of the device may be information about the use of a low-power standby mode and may be broadcasted to at least one neighboring devices one hop away from the device of the sleep information.

In another general aspect, there is provided a data storage medium storing a routing announce message, wherein the routing announce message includes a destination address having a broadcast address, a sleep start time indicating a start time of sleep mode and a sleep duration indicating how long a device remains in sleep mode.

In still another general aspect, there is provided a routing path establishment apparatus including a message transmitting/receiving unit to transmit and receive a route request command or a route reply command, a neighboring device table storing unit to store sleep information of a destination device and of all devices located on a path to the destination device, and a control unit to establish a path with reference to the stored sleep information.

In yet another general aspect, there is provided a ZigBee network which includes a plurality of devices, the ZigBee network storing sleep information of a destination device and of all devices located on a path to the destination device and establishing a path with reference to the sleep information.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a drawing illustrating how a device to enter in sleep mode broadcasts its sleep information to neighboring devices.

FIG. 2 is a drawing illustrating how a device which receives a route request command (RREQ) transmits sleep information of a destination device to a departure device.

FIG. 3 is a drawing illustrating how the destination device wakes up from the sleep mode and transmits a route reply command (RREP) to the device which receives a route request command.

FIGS. 4 to 6 are drawings for explaining a method of establishing a routing path when a device located on the middle of a routing path enters sleep mode according to an exemplary embodiment.

FIG. 7 is a drawing illustrating how a routing path is re-established when a sleep duration of the 18^{th} device in sleep mode exceeds a predetermined period of time.

FIG. 8 shows a sleep announce command according to an exemplary embodiment.

FIG. 9 is a flowchart illustrating a method of establishing a routing path according to an exemplary embodiment.

FIG. 10 is a block diagram illustrating a routing path establishment apparatus according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

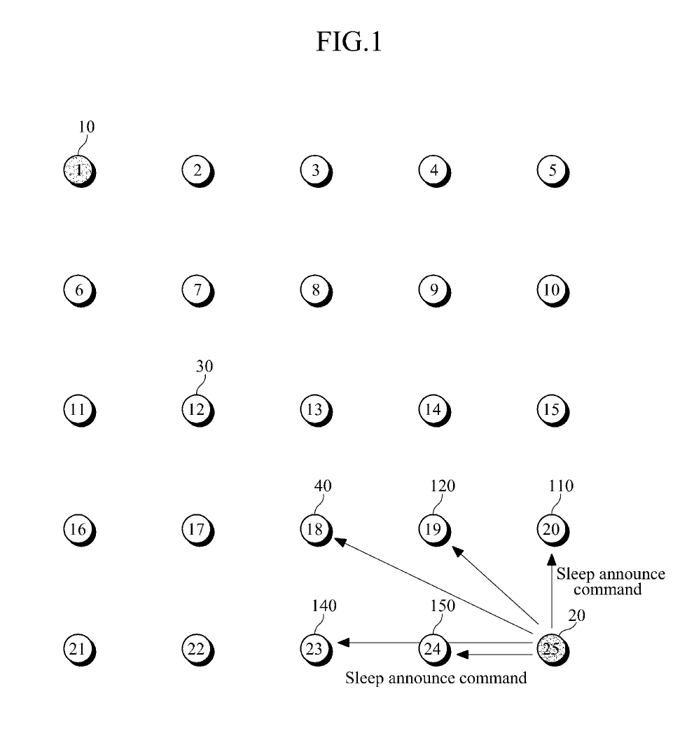

FIG. 1 is a drawing illustrating how a device entering into sleep mode broadcasts its sleep information to neighboring devices. In a non-beacon enabled ZigBee network, when a first device 10 searches for a path to a 25^{th} device 20, the first device 10 may broadcast a route request command (RREQ) to neighboring devices, receive a route reply command (RREP) from each neighboring device in response to the RREQ, and establish a path having an optimum routing cost, for example, a path from the first device 10 to the 25^{th} device 20 passing through a 12^{th} device 30 and a 18^{th} device 40.

However, if one of the devices on a path to be established enters sleep mode, it may be difficult to establish the routing path. The sleep mode may be a state where a device is deactivated and enters standby state with low power consumption.

For example, when the 25^{th} device 20, i.e., a destination device enters sleep mode, the first device 10 cannot receive any RREP from the 25^{th} device 20, and thus the first device determines that the 25^{th} device 20 does not exist in the network. Therefore, a device entering sleep mode needs to broadcast information that informs neighboring devices of its entry into sleep mode.

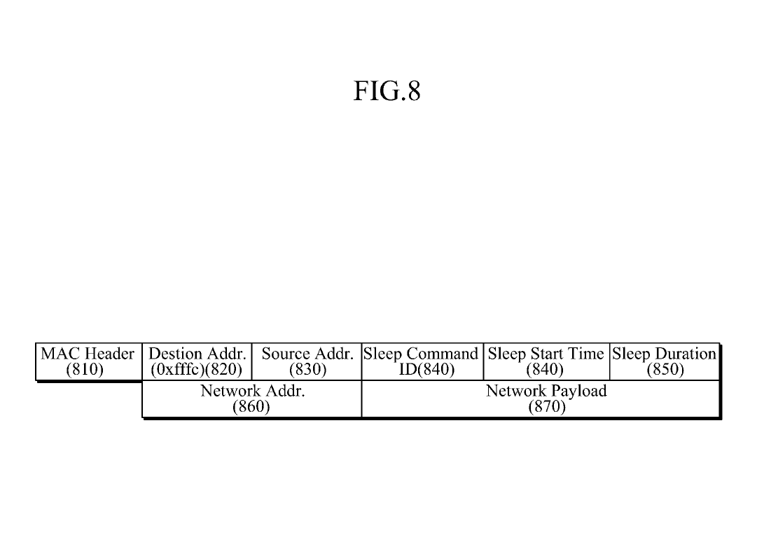

Referring to FIG. 1, the 25^{th} device 20, when entering sleep mode, broadcasts the information that notifies that the device 20 is entering sleep mode to neighboring devices 110, 120, 40, 140, and 150. The sleep information is broadcasted to the devices one hop away from the 25^{th} device 20. In this case, a destination address has 0xfffc indicating broadcast, and a is radius indicating a propagation range is 1. A sleep announce command to be broadcasted will be described with reference to FIG. 8.

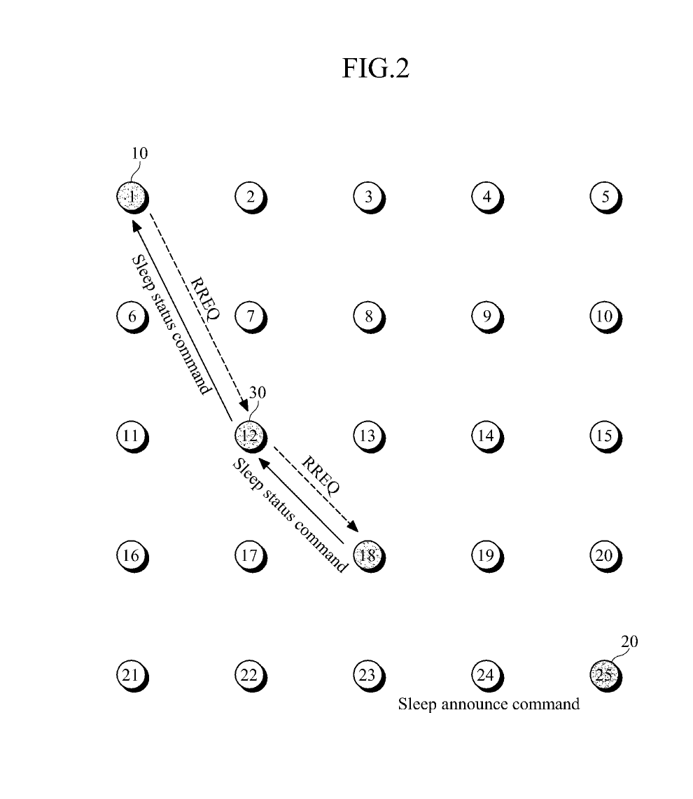

FIG. 2 is a drawing illustrating how a device 40 which receives an RREQ transmits sleep information of a destination device 20 to a departure device 10.

A neighboring device that receives a sleep announce command identifies a source address of the sleep announce command, and checks whether or not a device having the source address is present in a neighboring device table possessed by the device itself. If the device having the source address is present, the device sets a sleep start time, a sleep duration, and a sleep flag, and stores the set information in the neighboring device table.

To use the sleep start time and the sleep duration, time-synchronization between devices is required, but this does not fall under the scope of the present invention, and thus detailed description thereof will be omitted.

When the sleep announce command has been already transferred to the neighboring device and stored in the neighboring device table, a 12^{th} device 30 and an 18^{th} device 40 which receive an RREQ go through the following process.

The 18^{th} device 40 notifies a first device 10 through the 12^{th} device 30 that the 25^{th} device is currently in sleep mode by sending a sleep status command.

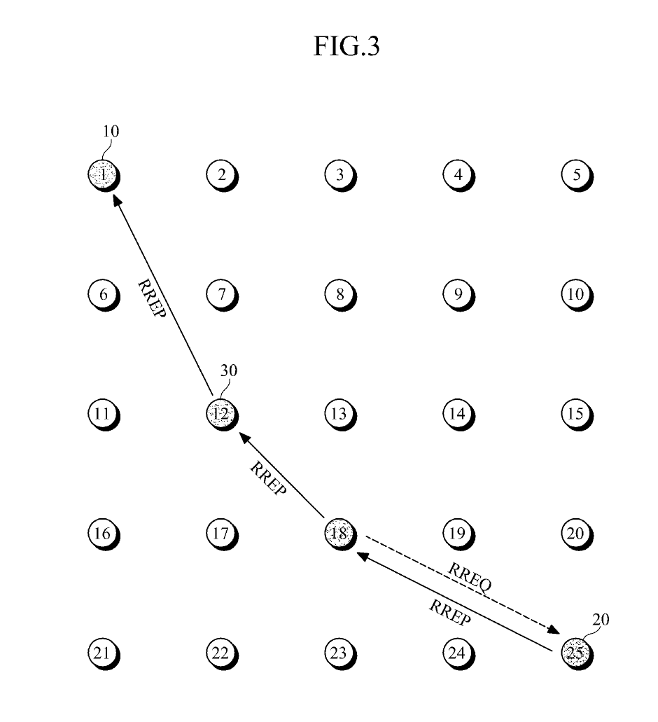

FIG. 3 is a drawing illustrating how the destination device 20 wakes up from sleep mode and transmits a route reply command (RREP) to the device 40 which receives a route request command.

In detail, once a 25^{th} device wakes up from sleep mode after a predetermined period of time, the 18^{th} device 40 broadcasts the RREQ again, and the 25^{th} device 20 transmits the RREP to the 18^{th} device 40 in response, so that a routing path from the first device 10 to the 25^{th} device 20 via the 12^{th} device 30 and the 18^{th} device 40 is established.

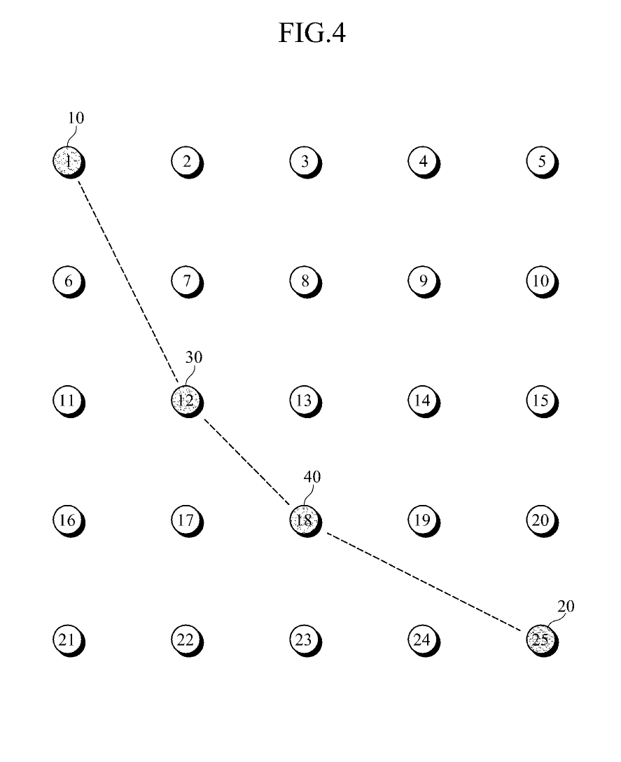

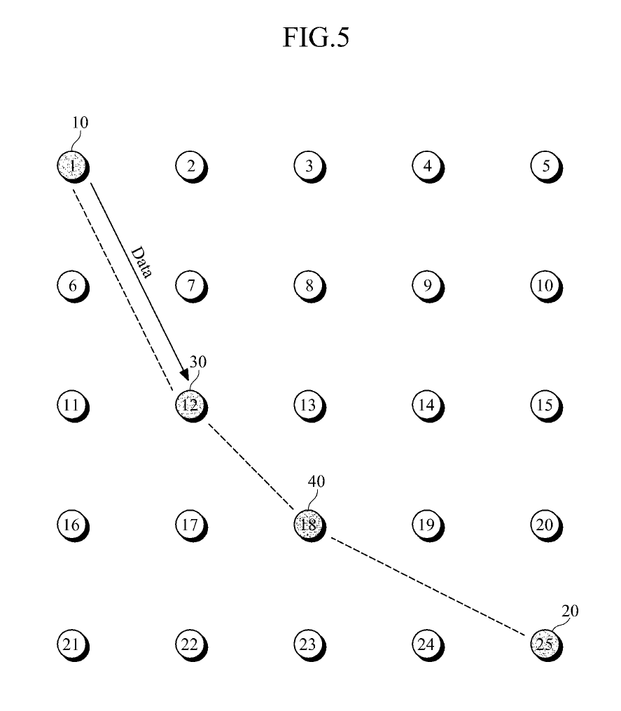

FIGS. 4 to 6 are drawings for explaining a method of establishing a routing path when a device 40 located on the middle of a routing path enters sleep mode according to an exemplary embodiment.

In other words, FIGS. 4 to 6 illustrates cases where a device on a routing path, which is not a destination device and was not in sleep mode when the routing path was established, enters sleep mode after a predetermined duration of time.

When a routing path from a first device 10 to a 25^{th} device 20 via a 12^{th} device 30 and an 18^{th} device 40 is established as shown in FIG. 4 and the 18^{th} device 40 enters sleep mode, it becomes impossible for the 12^{th} device 30 to transmit data to the 18^{th} device 40.

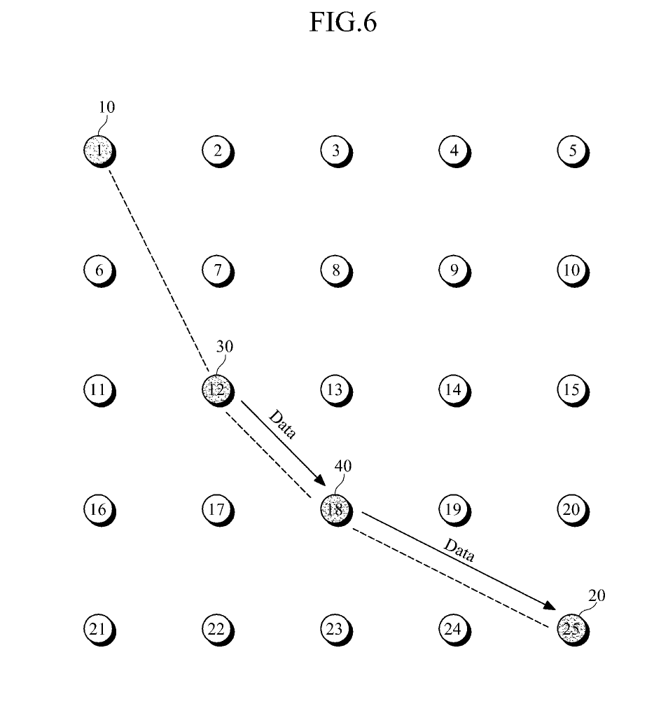

In this case, the 12^{th} device 30 refers to sleep information stored in its neighboring device table. That is, the 12^{th} device 30 waits for the 18^{th} device 40 to return to normal mode after a predetermined period of sleep time with reference to sleep start time and sleep duration of the 18^{th} device 40 contained in the sleep information. Then, the 12^{th} device 30 transmits data immediately after the 18^{th} device 40 wakes up from the sleep mode after the predetermined period of sleep time, as shown in FIG. 6.

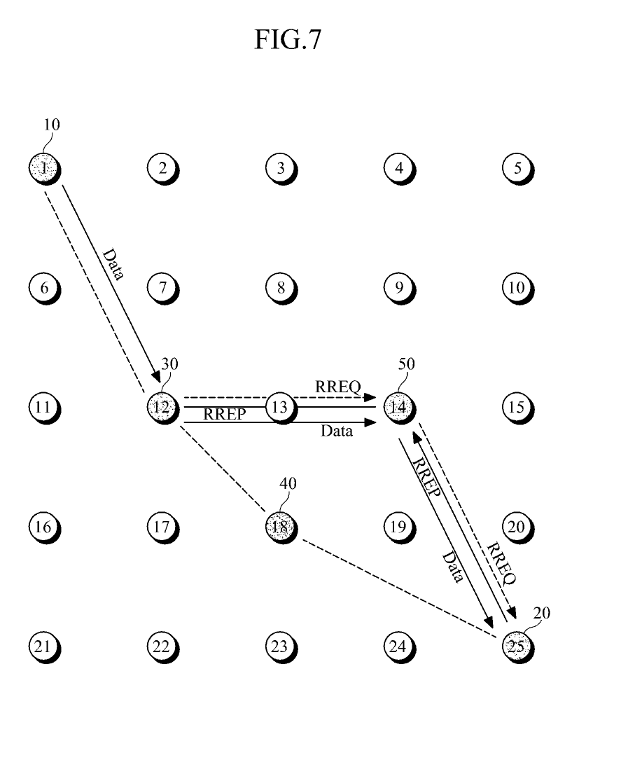

FIG. 7 is a drawing illustrating how a routing path is re-established when a sleep duration of the 18^{th} device 40 in sleep mode exceeds a predetermined period of time.

When it takes more than the predetermined period of time for the 18^{th} device to wake up, another routing path may be established as shown in FIG. 7. For example, a routing path may be re-established from the first device 10 to the 25^{th} device by passing through the 12^{th} device 30 and a 14^{th} device 50 via a 13^{th} device. Data is transferred over the re-established path.

FIG. 8 shows a sleep announce command according to an exemplary embodiment. Referring to FIG. 8, the sleep announce command includes a media access control (MAC) header 810, a destination address 820, a source address 830, a sleep command identification (ID) 840, a sleep start time 740, a sleep duration 850, a network address 860, and a network payload 870.

At the broadcasting of the sleep announce command, the destination address has a value of 0xfffc. The sleep start time 840 and sleep duration 850 may be set as described above.

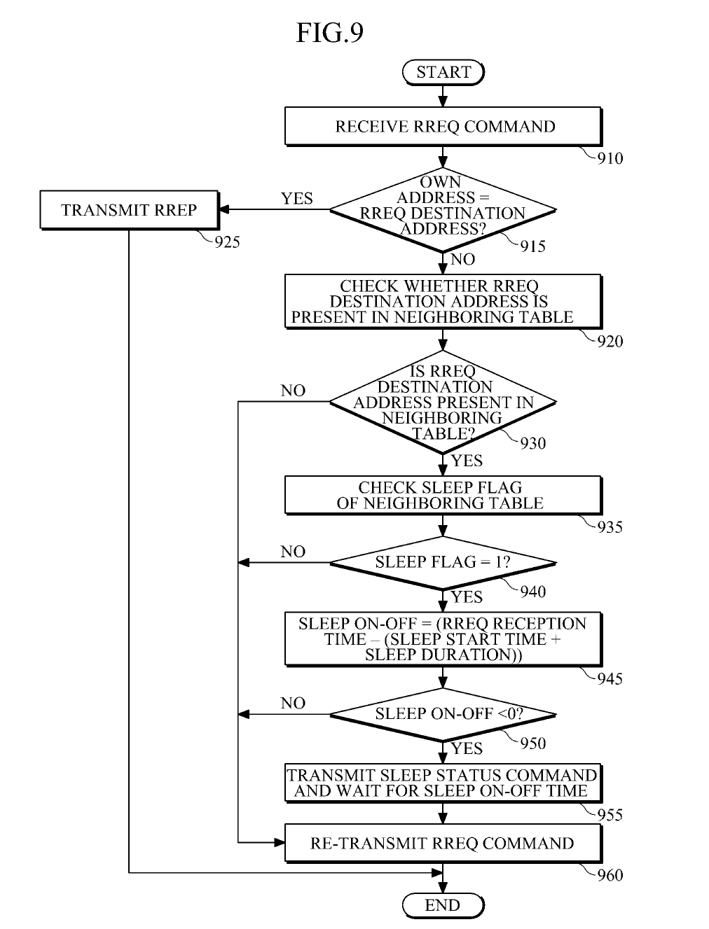

FIG. 9 is a flowchart illustrating a method of establishing a routing path according to an exemplary embodiment.

A device receives an RREQ (operation 910), and determines whether its address is identical with a destination address included in the RREQ (operation 915). If the address of the device is identical with the destination address, the device transmits an RREP in response (operation 925). If the address is different from the destination address, the device checks whether or not the destination address included in the RREQ is present in a neighboring device table possessed by the device (operation 920).

It is determined whether or not the destination address is present in the neighboring device table (operation 930), and if present, the device examines a sleep flag in the neighboring device table (operation 935). It is determined whether the sleep flag is set to 1 (operation 940), and if the sleep flag is 1, a sleep on-off is set to a value obtained by subtracting a sum of a sleep start time and a sleep duration time from a RREQ reception time (operation 945).

Thereafter, it is determined whether the sleep on-off is smaller than 0 (operation 950), and if the sleep on-off is smaller than 0, the device notifies of a sleep mode by transmitting a sleep status command and waits for the set sleep on-off time (operation 935). Then, the device re-transmits an RREQ command (operation 960).

Meanwhile, if it is determined that the destination address included in the RREQ is not present in the neighboring device table in operation 930, the sleep flag is not set to 1 in operation 940 or the sleep on-off is not smaller than 0, the device immediately re-transmits the RREQ is command (operation 960).

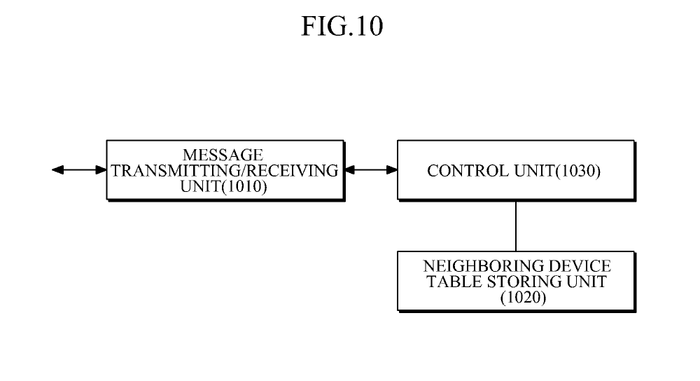

FIG. 10 is a block diagram illustrating a routing path establishment apparatus according to an exemplary embodiment. Referring to FIG. 10, the routing establishment apparatus includes a message transmitting and receiving unit 1010, a neighboring device table storing unit 1020, and a control unit 1030.

The message transmitting and receiving unit 1010 transmits and receives a route request (RREQ) command or a route reply command (RREP). The neighboring device table storing unit 1020 stores sleep information of a destination device and of all devices located on a path to the destination device. The sleep information has been described above with reference to FIG. 8. The sleep information is broadcasted to a device one hop away from the device to which the sleep information pertains.

The control unit 1030 establishes a path with reference to the stored sleep information. Specifically, the sleep information of the destination device and of all the devices located on a path to the destination device is checked, and the control unit waits for a device in sleep mode to return to normal mode according to the sleep information and then establishes the path. Alternatively, the control unit 1030 may check the sleep information of the destination device and of all the devices located on a path to the destination device and establish another path if it takes more than a predetermined period of time for a device in sleep mode to return to normal mode.

According to the exemplary embodiments, while the devices are allowed to sleep for energy efficiency even in a non-beacon-enabled mode, an ad-hoc on-demand distance vector (AODV)-based mesh routing method which uses a route request command (RREQ) and a route reply command (RREP) can be used as is, and thus the ZigBee network can be utilized in more various application fields.

The invention can also be embodied as computer readable codes on a computer readable is recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A routing path establishment method comprising:
receiving a route request command; and
establishing a path with reference to sleep information of a destination device and of all devices located on a path to the destination device.

2. The routing path establishment method of claim 1, wherein the sleep information of the device is information about the use of a low-power standby mode and is broadcasted to at least one neighboring device one hop away from the device of the sleep information.

3. The routing path establishment method of claim 1, wherein the sleep information includes a destination address having a broadcast address, a sleep start time is indicating a start time of the sleep mode and a sleep duration indicating how long the device remains in the sleep mode.

4. The routing path establishment method of claim 1, wherein the establishing of the path comprises identifying a source address contained in the sleep information and checking whether or not a device having the identified source address is present in a neighboring device table possessed by the device to which the sleep information pertains, setting and storing a sleep start time, a sleep duration and a sleep flag into the neighboring device table if the device having the identified source address is present in the neighboring device table, and establishing the path with reference to the neighboring device table storing the sleep start time, the sleep duration and the sleep flag.

5. The routing path establishment method of claim 1, wherein the establishing of the path comprises checking the sleep information of the destination device and of all the devices located on a path to the destination device, waiting until a device in sleep mode returns to normal mode according to the sleep information and establishing the path.

6. The routing path establishment method of claim 1, wherein the establishing of the path comprises checking the sleep information of the destination device and of all the devices located on a path to the destination device and searching for another path instead of the predetermined path when it is found from the sleep information that it takes more than a predetermined period of time for a device in sleep mode to return to normal mode.

7. The routing path establishment method of claim 1 being performed in a non-beacon enabled ZigBee network.

8. A data storage medium storing a routing announce message, wherein the routing announce message comprises a destination address having a broadcast address, a sleep start time indicating a start time of sleep mode and a sleep duration indicating how long a device remains in sleep mode.

9. The data storage medium of claim 8, wherein the routing announce message is broadcasted to at least one neighboring device one hop away from the device in sleep mode.

10. A routing path establishment apparatus comprising:
a message transmitting/receiving unit to transmit and receive a route request command or a route reply command;
a neighboring device table storing unit to store sleep information of a destination device and of all devices located on a path to the destination device; and
a control unit to establish a path with reference to the stored sleep information.

11. The routing path establishment apparatus of claim 10, wherein the sleep information of the device is information about the use of a low-power standby mode and is broadcasted to at least one neighboring device one hop away from the device in sleep mode.

12. The routing path establishment apparatus of claim 10, wherein the control unit checks the sleep information of the destination device and of all the devices located on a path to the destination device to the destination device, waits until a device in sleep mode returns to normal mode according to the sleep information and then establishes the path.

13. The routing path establishment apparatus of claim 10, wherein the control unit checks the sleep information of the destination device and of all the devices located on a path to the destination device to the destination device and searches for another path instead of the predetermined path when it is found from the sleep information that it takes more than a predetermined period of time for a device in sleep mode to return to normal mode.

14. A ZigBee network which includes a plurality of devices, the ZigBee network storing sleep information of a destination device and of all devices located on a path to the destination device and establishing a path with reference to the sleep information.
